(19) United States
(12) Patent Application Publication
(10) Pub. No.: US 2020/0072199 A1
(43) Pub. Date: Mar. 5, 2020

(54) System for the non conventional production of electrical power from a geothermal source and relevant party

(71) Applicant: VES Energy S.r.l., Milan (IT)

(72) Inventors: Ranieri Fontana, Milan (IT); Giuseppe Cermentini, Milan (IT)

(21) Appl. No.: 16/610,543

(22) PCT Filed: May 4, 2017
(86) PCT No.: PCT/IB2017/052605

§ 371 Date: Nov. 4, 2019

(51) Int. Cl. F03G 7/04; F25B 30/06

(52) U.S. Cl. CPC F03G 7/04; F24T 10/13; F25B 30/06

(57) ABSTRACT

Electrical energy production system from non- conventional geothermal source in formations at prevalent vapour based on the fact it is composed by a geothermic well made up with a heat pump integrated in the depth of the well, the mentioned heat pump is composed by extended concentric pipes system, the bigger diameter duct of which is used for the thermic exchange and the rising of the transport fluid heat and the small diameter duct operating for the transport fluid from outside up to its lower extremity.

### FIELD OF THE INVENTION

This invention concerns the geothermal energy transformation systems at a low and medium enthalpy, for electrical energy production and or for civil uses. Besides, the invention concerns the plant that uses such systems.

### BACKGROUND OF THE INVENTION

It is known, from the first years of the last century, the exploitation of the geothermal electrical energy in plants of industrial type; such plants are very widespread, especially in Italy, where the subsoil energy exploitation dates back to 1913, and in Iceland, where they have a huge importance, due to food self-sufficiency in the country.

Italy still maintains substantial geothermal reserves divided in three groups; low enthalpy, (t<90° C.), medium enthalpy (t<150° C.), high enthalpy (t>150° C.). A high part of the reserves at a low and medium enthalpy by prevalent liquid are, still, not exploited. A great part of the reserves at high enthalpy by prevalent steam are exploited, but wide opportunities still exist in order to realise new plants.

The exploitation of the geothermal energy, besides the geological difficulties concerning the correct identification of the useful sites, exhibits some technical and administrative problems, which make complicated the start-up of a geothermal energy exploitation plant.

In particular, the first obstacle is caused by technical matters, that is to say by the drilling of wells, and therefore by the evaluation of the geological formation to pass through. Moreover, the pollution problems connected to the drillings are apparent, made bigger in that often the geothermal sources lead to the emission of fizzy substances polluting the atmosphere, in particular composed of sulphur. Events of micro seismic in the interested areas have been observed, caused by the re-injections of fluids. Finally, the environmental politics have correctly assumed peculiar importance and, as a matter of fact, the consequences on the ecosystems where to work in, must be considered while creating a new system.

Finally, the systems so far known are water pumping stations and, consequently, the policy of a correct water management, recently considered essential element for an eco-friendly development, also assumes great importance under a strategic and a communicative point of view, and also economic. These problems cause wide complications in the arrangement of the total productive system and have considerable impact, both on the realisation times and on the investments and running costs.

A geothermal energy recovery procedure is known from U.S. Pat. No. 3,957,108 a that foresees a heat exchange system, suitable for the problems reduction connected to the disposal of the harmful components.

However, from the description and figures, it can be noticed that the system is not totally closed and therefore it does not fully solve any of the mentioned problems.

### Problem and Solution

The problem under the invention is, as a matter of fact, to propose a system which overcomes those inconveniences and allows, besides, the realisation of a system at reasonable prices, in order to increase, at the same time, the energetic efficiency system and thus get better performances.

In particular, object of this invention is the realisation of a system which does not include re-injections wells, does not bring the flow harmful fluids the surface, minimizes the corrosion or the deposit of saults and can limit the environmental impact, vehicle reducing the exposed structures on to the landscape and the changes of the ecosystem near by the plant.

Such object is reached through a closed circuit system—according to this invention, and is stated very briefly—which includes the phases:

introduction of a heat exchanger in the sub-soil into the well, connected to the surface plants by an up and down stream;

injection of a carrier fluid (usually demineralized water) into the mentioned heat exchanger in order to completely vaporise it;

leaking of the vapour and or of the hot water from the mentioned heat exchanger and lead to the surface through the down stream.

use of the vapour and or of the hot water generated for the production of electrical energy or for the civil uses which can be of interest for the area.

Together with the heat extraction system, a system of production of electric power by turbine is conventionally foreseen, assembled with cooling systems for the next total steam condensation and the re-injection in the sub-soil.

Further object of this invention is, therefore, the realisation of a simplified geothermal electrical energy production system in order to obtain a high efficiency, coupled with a reduced environmental-landscape impact.

The mentioned object is obtained through a geothermal heat extraction system from the geological formation for an electrical energy production system charicterised in that the following phases are provided:

the throwing into a geothermal well of a carrier fluid, cleaned in liquid phase through a specific isolated duct

heat exchange inside a sealed room laid out within the mentioned geothermal well between the carrier fluid and the fluid in the geological formation

the rising of the carrier fluid in the form of overheated steam, up to the electrical energy production plant.

### BRIEF DESCRIPTION AND DRAWINGS

Further features and advantages invention are better understood from the following detailed description of two favourite embodiments, provided as a neat example and not limiting describing the attached drawings, where:

FIG. 1 is a view in cross section of a geothermal spring of prior art;

FIG. 2 is a schematic view in cross section of a geothermal well of the system, according to a first embodiment of the invention, suitable for prevalent steam tanks;

FIG. 3 is a schematic view of the system according to the invention, as foreseen on the surface;

FIG. 4 is a schematic view in cross section of a geothermal well of the the system, according to a second embodiment of the invention, suitable for prevalent liquid tanks, of which

FIG. 5 is a particular of the heat exchange area.

### DETAILED DESCRIPTION OF THE FAVOURITE EMBODIMENT

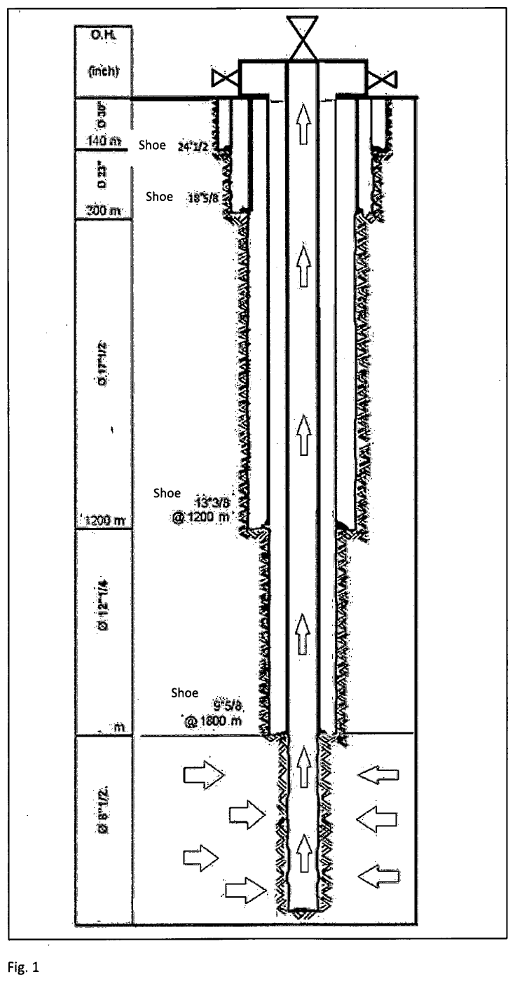

Usually, as described in FIG. 1, a geothermal well is composed of a series of concentric cementated pipes, having growing length as the diameters diminish. The drilling area by the geothermal tank, which inside contains the fluid at high temperature, is generally left without the pipe protection until the maximum depth of the well. The closing of the spring on the surface is realised through a high safety valve system (head of the well). The well realised in this way can produce, in case of an electrical energy generation plant, a quantity of geothermal steam water, enough for the feeding a group of electric turbo generation, guaranteeing the cost savings. While approaching the exit of the turbo generation plant, the steam is completely condensed and the liquid is re-injected into the geothermal tank through dedicated wells, in order to maintain as constant as possible the tank pressure and to limit the exhaustion times.

Likewise, in the case of a well for the prevalent liquid extraction at high temperature, the solution described now can however feed the hot water services of important utilities, like hospitals, schools or different offices, guaranteeing savings.

The finding foresees instead, according to the invention, to change the internal well structure, in order to acquire further advantages for the complex of the system.

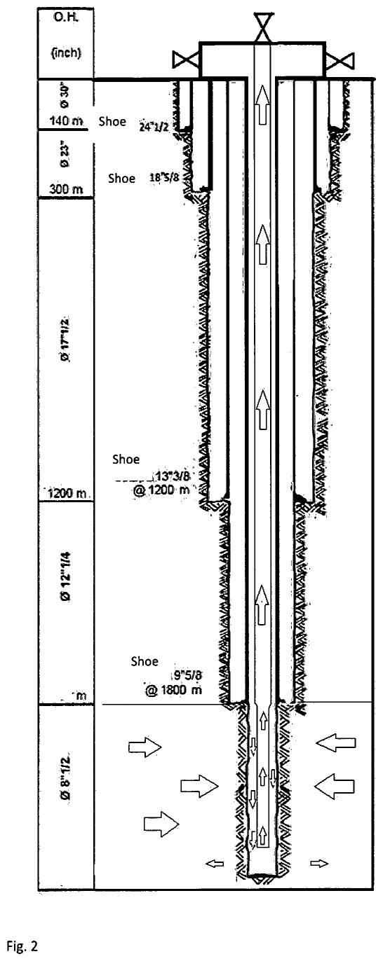

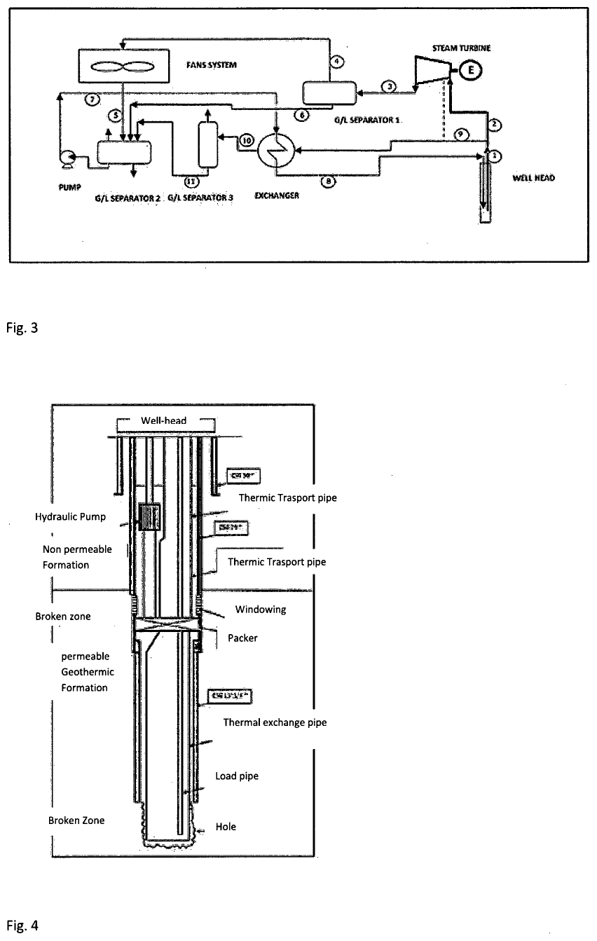

In the first favourite embodiment, well shown in FIG. 2, indeed, the system foresees the introduction into the geothermal well of a heat exchanger, mainly composed of a system with two concentric pipes, extended almost up to the bottom of the well, of which the one inside, of a smaller diameter, is lower opened and suitable to lead the carrier fluid into the well during the liquid phase, having origin from the station, while the external one is lower closed and suitable to let the carrier fluid come to the surface during the steam phase.

The geothermal heat exchanger is structured so as to be completely isolated from the sub-soil and the surrounding environment, in order to lead to the surface and carry to the electrical energy generation plant at low power (not shown in the drawing) exclusively the steam which is created inside following the carrier fluid overheating, generally made up of pure water or of other suitable compound. In fact, it is not necessary to contact the geological formations and thus it is impossible the leak of formation liquid, for example from the composed sulphur, contained in the well.

Now, in order to definitively understand the operations of the geothermal electrical energy production system, which is subject to protection, we here point out the process which origin the electrical energy production according to the present invention.

A carrier fluid in the liquid phase is pumped through the duct of small size, up to the bottom of the heat exchanger, composed of a bigger pipe closed at the bottom, to let the heat exchange occur with a high heat source, made up by the fluid at high temperature in the geothermical tank. By warming up, the carrier fluid, generally composed of water without salts or of any other component, evaporates and is consequently taken to return along the transport pipe, overheating during the rising due to the exchange with the fluid contained in the geothermic well. Once reached the head of the well, the steam is carried through a suitable pipe to the electrical energy production system, typically composed by a steam turbine coupled with a generator.

After transferring its thermic energy, the steam is completely condensed, falling to the bottom of the well, where it starts the cycle again, in fact making a circular flow of steam natural connections.

The leaks of the carrier fluid are very scarce, and therefore the process takes place through a a very low water consumption.

Outside the heat exchanger, in the gap between it and the drilled formation, there is the condensation of the formation fluid, generally composed of steam close to the saturation. As long as the fluid condenses, it falls up to the bottom of the well, where it is re-absorbed inside the geological formation.

The thermal exchange between the formation fluid outside the heat exchanger and the carrier fluid inside the same is guaranteed outside by the steam condensation present in the tank and inside by the evaporation of the carrier fluid. Both those mechanisms are characterised by a high thermic efficiency.

To further guarantee the water level maintenance in correspondence to the geothermal tank, it is possible to foresee a well protection with a perimeter cemented place enclosing the pipe with the bigger diameter between the mentioned cemented place and the well, as an airlock is foreseen, through which the steam coming from the process inside the electrical energy generation plant is sent again.

The released steam condenses while falling and balances again the quantities of water in the tank.

To allow the heat exchange at the proper conditions, the central pipe, also known as formation pipe, is completely isolated from the heat carrier fluid on the surface. To obtain the best performances, the formation pipe has preferably a diameter of 140 mm.

On the surface, it is present a plant of electrical energy generation, activated by a steam turbine at low power, of conventional type (radial turbine) or of more innovative type (Turboden turbine), schematically described in picture 3. As it appears to a skilled person, the mentioned system does not have innovative characteristics and it is here not further described, not to make heavier the description adding no relevant technical details.

The system described now is however structured in order to define a synergy between the thermal exchanger extracted in the geothermal well and the area surrounding it.

To let the system work with the desired features, it is necessary to identify three different zones inside the exchanger:

the lower zone, of limited length, where the carrier fluid injected in the lowest part through a small diameter pipe, overheats, reaching the boiling temperature;

the intermediate zone of bigger length, where the carrier fluid is completely vapourised;

the upper zone where the carrier fluid is overheated inside the pipe.

At the same time, to define the system completely closed, it may occur a condensation of the formation fluid outside. For this purpose, the chamber formed between the most external walls of the well and the external wall of the biggest pipe diameter is expected.

In light of what described above, it is clear that the exchange mechanism in the geothermal tank is a condensation type for natural convention.

The electric power of the well generated is strongly dependent on the enthalpy specific of the formation fluid. The limiting element of the well productivity is not represented by the thermal exchange, which is indeed very efficient, but instead by a headwell conducting system of the carrier fluid. The thermal exchange coefficients generally assume, in this case, very high values because they correspond to states of the phase change (condensation of the formation fluid outside the pipe and carrier fluid vapourisation inside); assuming a thermal exchange coefficient value of 1,2 KW/MQ ° C,: with an exchange surface of 200 m², almost equivalent to 500 mm of a 7″ pipe (17,78 cm), and a temperature difference of 50° C., the thermal potentiality results in being 12 Mw value at medium pressure, which can generate an electric power of around 3 Mw.

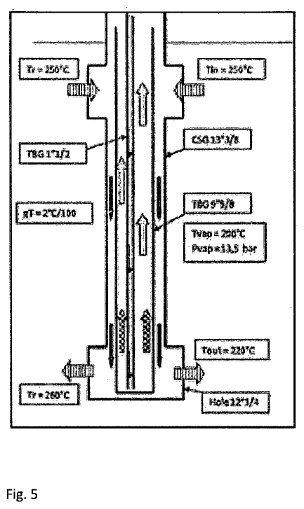

In the second embodiment, described in the FIGS. 4 and 5, the last piping of cemented protection is examined in depth inside the geothermal tank and is conveniently drilled in an upper zone, the lowest extremity of the well ends with a non-piped section (open hole).

In particular, the well structure inside foresees a complex system of thermal exchange, composed by different elements on two lines. The carrier fluid line is made up by the heat exchanger and the carrier piping to the surface; on this line, a telescopic mechanical element is connected, which allows the length change over a fixed mechanical element, called packer.

The liquid formation line is mainly composed by a hydraulic pump, which pumps liquid into the spring through a window of the upper zone and re-injects it into a deeper zone through the transfer duct of the carrier fluid.

The fluids exchanging thermal energy: formation fluid and carrier fluid are always completely separated inside the well. The thermal energy transport process happens in the following way:

The carrier fluid (pure water), injected into the well in liquid phase overheated through a small diameter pipe, absorbs the heat from the internal exchange pipe wall and vapourises,

The steam rises to the head of the well through a transport duct, pours out the well and is carried to the thermoelectric station, from where it returns in the form of overheated liquid,

Through a pump, the formation fluid (liquid) is taken from the upper zone of the reservoir and is pushed into contact to the exchange external wall at a high speed, giving heat and then cooling.

The formation fluid (liquid) returns into the lower zone and a convention circular flow is formed by virtue of the liquid density differences generated by the cooling; the exhausted fluid tends to stay in the lowest part of the reservoir, where it will quickly heat in contact with the rock.

Consequently, the two zones inside the well are hydraulically separated from the mechanical element called packer, common to the two lines, fixed on the wall of the protection pipe.

In the gap between the isolated formation pipe and the external cemented station of protection and housing, a further duct, open in the lower part, is inserted on which a supply pump of the carrier fluid is mounted, towards the geothermal tank.

To allow the correct operation and to avoid vibrations or—in the most serious cases—collisions, the two pipes are held in stable position by a hold element of the mutual position of the two pipes, which must be parallel.

In this case, as it will be better understandable from the operation description, the thermal exchange outside the exchanger is guaranteed by the formation circulation water inside the well, produced with the help of the electric pump.

From the description, which precedes, it fully appears apparent that the geothermal non-conventional systems here described provide a thermal exchange at high efficiency occurring in the well between the fluid present in the geothermal formation—contaminated steam water or liquid water at high temperature—and the carrier fluid, composed of high purity water or other component.

It could be understood, therefore, that the invention described in this way satisfies the predetermine aims, achieving an economically affordable system, with a remarkable reduction of the environmental impact—both with regard to the landscape impact and the pollution effects linked with the contaminated formation fluid extraction, by reducing the enthalpy leaks for a decrease of the temperature inside the well, due to the excessively cold water injection and or at complete contact with the interior part of the well.

It can be indeed noticed that the systems now introduced do not imply the polluted formation fluid extraction, but only the heat extraction through a carrier fluid device, because of the thermal exchange at high efficiency with the fluid existing inside the formation. Furthermore, from the realised and described process, no contaminated fluid is input into the environment and no re-flowing to be re-injected into the geological formation exist.

As it can be well understood, the described solution in the second embodiment appears particularly versatile, since it can be used—with economically sustainable advantages—also in already developed oilfields at low enthalpy, near residential and/or industrial areas for heating and or cooling uses.

We can well understand, from the previous description, that these technical solutions allow to reduce the number of drilled wells and to simplify the plants on the surface, eliminating the expensive purification systems of the fluids pumped into the atmosphere, minimising, generally, the environmental pollution risks.

For that reason, also the predetermined aim of a non-conventional plant for the use and management of the geothermal energy production is obtained, which can combine a limited environmental and landscape impact with high energetic efficiency values.

In particular, an innovative closed system circuit is obtained, through which the geothermal heat at high temperature is transferred to a carrier fluid into the depth well, by means of thermal exchange pipe inserted in the well which allows a heat exchange at high efficiency between the fluid present in the geothermal formation and the carrier fluid, composed of water at high purity.

The carrier fluid is injected into the well in liquid form, conveniently overheated and vapourises inside a pipe completely isolated from the well, then it flows out the well at a sufficiently high pressure and at a temperature slightly lower than the formation and feeds an electricity generation plant (turbogenerator). At the exit of the generation plant, all steam produced by the well is condensed again and pumped into the well with much reduced leaks.

This closed circuit system can, in specific geological conditions, have a good potentiality and a similar efficiency, if not higher, to the original geothermal fields with fluids re-injection produced in the deep-water bearing.

However, in addition, this system is excellent from an environmental point of view: indeed, the pollutants contained in the geological formation are never, in no occasion, dispersed in the external surrounding. On the other hand, the pollution chances of the underground strata with superficial fluids will be reduced.

Finally, in the end, the problems concerning the temperature fluids reduction of formations caused by the re-injections of those fluids at lower temperature are deeply restrained. Then:
costs reduction with the same potentialities
no harmful emission gases or greenhouse effect into the atmosphere
environmental sustainability, as no exhaustible resources are used.

Besides, it is proven that the suitable solution for prevalent steam tanks can also be applied when the sub-soil is composed of geological formations at low permeability, which cannot be exploited through the known technical systems.

The potentialities of development on the territory is therefore expanded.

In the case of tanks at prevalent liquid, the preliminary calculations of the exchange coefficients indicate the possibility of obtaining a quantity of headwell steam sufficient to generate an electric power of more than 3 electric MW with an exchange length zone quite contained (around 500 pipe meters). Taking into consideration a coefficient value of 1,0 KW/mq° C. thermal exchange, an exchange surface of 400 mq, equivalent to almost 500 m pipe 9″⅝ (24, 45 cm), a difference in medium temperature of 33° C., the thermal exchange potentiality results in being 13 MW. The values considered above have been chosen and simulated with considerable caution and we can consider that a more mature evaluation, during the execution planning, can reveal more elevated values, at least by 30%.

The completion model mentioned above is suitable for applications in geothermal reservoirs characterised by a very low temperature gradient in the formation, corresponding to 1-5° C./100 m, typical in the permeable formations usually for natural fracking.

Equally, the risk of events linked to influences on the geological system plan of the interested area, like seismic of minimum entity or subsidence events is much reduced, as the system described now does not provide injections of formation fluids, but only heat exchange in depth.

Lastly, also the chemical pollution risk is nearly null, as the wells are isolated from the sub-soil. CO₂ and H₂S emissions in atmosphere are, therefore, not foreseen, or other emissions from the plants during the production phase.

The remarkable scope of the solution reported above has been, in this manner, revealed.

We have, however, to understand that the invention must not be considered limited to the particular instructions described above, which only represent an exemplifying embodiment of it, but that different variants are possible.

1) Heat extraction system from geothermal source, including a geothermal well and a fluid carrier piping type from the bottom of the well to the surface, characterised in that such carrier piping includes an up and a down stream branch, which connect at fluid tight through a heat exchanger, put at the bottom of such geothermal well, said heat exchanger being composed of extended concentric pipes system, the biggest diameter duct serving for the heat exchange and the rising of the heat carrier fluid while the small diameter duct is needed for the feeding of carrier fluid from outside, up to its lower extremity.

2) System as in claim 1), characterised in that an airlock between the mentioned heat exchanger and a geothermal formation suitable in allowing the evacuation of the condensed phase is provided.

3) System as in claim 1), characterised in that such concentric pipes are extended up to almost the bottom of the well.

4) System as in claim 1), characterised in that is protected by a cementing perimeter place which encircles such bigger diameter pipe, between the mentioned place and mentioned pipe as an airlock through which the exhausted steam is foreseen.

5) System as in claim 1, characterised in that such pipe of smaller diameter is completely isolated from the carrier fluid in the surface.

6) System as in claim 5), characterised in that such isolated pipe has a diameter of around 140 mm.

7) System as in claim 1, characterised in that a piping system of the carrier fluid duct is foreseen in the different liquid phases and vapour between the well and the electrical energy generation plant and the same plant.
